(19) United States
(12) Patent Application Publication
(10) Pub. No.: US 2025/0119443 A1
(43) Pub. Date: Apr. 10, 2025

(54) ANOMALY CAUSE ESTIMATION APPARATUS, ANOMALY CAUSE ESTIMATION METHOD, AND COMPUTER-READABLE RECORDING MEDIUM

(71) Applicant: NEC Corporation, Minato-ku, Tokyo (JP)

(72) Inventors: Shohei MITANI, Tokyo (JP); Hirofumi UEDA, Tokyo (JP)

(73) Assignee: NEC Corporation, Minato-ku, Tokyo (JP)

(21) Appl. No.: 18/567,411

(22) PCT Filed: Jun. 10, 2021
(86) PCT No.: PCT/JP21/22050

§ 371 Date: Dec. 6, 2023

(51) Int. Cl. H04L 9/40; G06F 11/07; G16Y 40/10

(52) U.S. Cl. CPC H04L 63/1425; G06F 11/079; G16Y 40/10

(57) ABSTRACT

An anomaly cause estimation apparatus includes: an anomaly detection unit converts a data series acquired in a time series from a plurality of components provided in a target system into an anomaly level data series, and detects an anomaly based on the obtained anomaly level data series; and an anomaly propagation estimation unit inputs a target anomaly level data series, extracted from the anomaly level data series, for a period before a point in time at which the anomaly is detected, a target data series corresponding to the target anomaly level data series, and information indicating a causal relationship between the components to an anomaly propagation estimation model, and estimates an anomaly propagation likelihood of the anomaly propagating between the components.

### TECHNICAL FIELD

The present invention relates to an anomaly cause estimation apparatus and an anomaly cause estimation method for estimating the cause of an abnormality in a system, and further relates to a computer-readable recording medium that includes a program recorded thereon for realizing the apparatus and method.

### BACKGROUND ART

In order to securely operate an OT (Operational Technology)/IoT (Internet of Things) network, when an anomaly is detected in a target system, the cause of the anomaly needs to be estimated and prompt action taken. Also, the target system needs to be protected from threats that have infiltrated the target system.

Patent Document 1 discloses an anomaly diagnosis system that is able to represent a propagation relationship between elements, and readily estimates the element that causes the anomaly. The anomaly diagnosis system of Patent Document 1 detects changes in the state of operation data, using a detection unit set for each element. Operation data is data obtained by measurement values measured by a plurality of sensors included in the elements being enumerated in a time series.

Also, the anomaly diagnosis system of Patent Document 1 estimates the element that causes the anomaly, using the influence of the upstream element on the downstream element (propagation relationship between elements), the point in time at which the state change of the operation data is detected, and the operation data that caused the state change.

### LIST OF RELATED ART DOCUMENTS

### Patent Document

Patent Document 1: International Publication No. WO/2017/159016

### SUMMARY OF INVENTION

### Problems to be Solved by the Invention

However, the anomaly diagnosis system of Patent Document 1 only gives a score to the detection unit set for each element, using criteria set in advance, and estimates the element corresponding to the detection unit having the highest overall score as the anomaly cause.

Note that criteria include (1), (2), and (3) shown below, for example.
(1) A higher score is given to a detection unit further on the upstream side (further upstream) in the target system. (2) A higher score is given to a detection unit whose state change is detected earlier. (3) A higher score is given to a detection unit whose operation data that caused the state change does not include an input condition.

As one aspect, an example object is to provide an anomaly cause estimation apparatus, an anomaly cause estimation method and a computer-readable recording medium that estimate a true anomaly cause based on propagation of an anomaly.

### Means for Solving the Problems

In order to achieve the example object described above, an anomaly cause estimation apparatus according to an example aspect includes:
an anomaly detection unit that converts a data series acquired in a time series from a plurality of components provided in a target system into an anomaly level data series, and detects
an anomaly based on the obtained anomaly level data series; and an anomaly propagation estimation unit that inputs a target anomaly level data series, extracted from the anomaly level data series, for a period before a point in time at which the anomaly is detected, a target data series corresponding to the target anomaly level data series, and information indicating a causal relationship between the components to an anomaly propagation estimation model, and estimates an anomaly propagation likelihood of the anomaly propagating between the components.

Also, in order to achieve the example object described above, an anomaly cause estimation method according to an example aspect includes:
a step of converting a data series acquired in a time series from a plurality of components provided in a target system into an anomaly level data series;
a step of detecting an anomaly based on the obtained anomaly level data series; and
a step of inputting a target anomaly level data series, extracted from the anomaly level data series, for a period before a point in time at which the anomaly is detected, a target data series corresponding to the target anomaly level data series, and information indicating a causal relationship between the components to an anomaly propagation estimation model, and estimating an anomaly propagation likelihood of the anomaly propagating between the components.

Furthermore, in order to achieve the example object described above, a computer-readable recording medium according to an example aspect includes a program recorded on the computer-readable recording medium, the program including instructions that cause the computer to carry out:
a step of converting a data series acquired in a time series from a plurality of components provided in a target system into an anomaly level data series;
a step of detecting an anomaly based on the obtained anomaly level data series; and
a step of inputting a target anomaly level data series, extracted from the anomaly level data series, for a period before a point in time at which the anomaly is detected, a target data series corresponding to the target anomaly level data series, and information indicating a causal relationship between the components to an anomaly propagation estimation model, and estimating an anomaly propagation likelihood of the anomaly propagating between the components.

### Advantageous Effects of the Invention

As one aspect, it is possible to estimate a true anomaly cause based on propagation of an anomaly.

### BRIEF DESCRIPTION OF THE DRAWINGS

FIG. 1 is a diagram for describing an example of the anomaly cause estimation apparatus.

FIG. 2 is a diagram for describing an example of conversion to an anomaly level data series.

FIG. 3 is a diagram for describing an example of propagation of an anomaly.

FIG. 4 is a diagram for describing an example of propagation of an anomaly.

FIG. 5 is a diagram for describing the anomaly level in normal data.

FIG. 6 is a diagram for describing the relationship between the variable space and the anomaly level data series.

FIG. 7 is a diagram for describing the relationship of the anomaly levels between components.

FIG. 8 is a diagram for describing overall inference of the anomaly cause.

FIG. 9 is a diagram for describing overall inference of the anomaly cause.

FIG. 10 is a diagram for describing an example of anomaly cause information.

FIG. 11 is a diagram for describing an example of a system having the anomaly cause estimation apparatus.

FIG. 12 is a diagram for describing an example of the operations of the anomaly cause estimation apparatus.

FIG. 13 is a diagram for describing an example of a computer that realizes the anomaly cause estimation apparatus.

### EXAMPLE EMBODIMENTS

First, an overview will be given to facilitate understanding of an example embodiment described below.

Conventionally, a component with respect to which an anomaly was detected was specified as the cause of the anomaly. However, the specified component is actually not always the root cause that brought about the anomaly (true cause of the anomaly). In view of this, it is desired to estimate the component that is the root cause that brought about the anomaly.

However, in order to specify the true cause of an anomaly (root-cause analysis) that cannot be judged directly from the result of detecting the anomaly, detailed design information or a large amount of anomalous data is required.

Specifically, in the case where a model for specifying a causal cause generated using detailed design information of the target system is used, the causal cause can be specified at the component level. However, generating models is expensive. Furthermore, relationships that occur by chance cannot be reflected in a model.

Also, in the case where a model is used that specifies causal causes, having been generated using labeled anomalous data, large amounts of anomalous data must be collected. However, it is difficult to collect large amounts of anomalous data. Also, unknown anomalies cannot be classified with a model.

In the case where a model is used that specifies causal causes, having learned behavior at the time of anomalies using unlabeled anomalous data, unknown anomalies can also be classified. However, it is difficult to collect anomalous data. Also, it is difficult to determine (interpret) anomalies in data. Furthermore, estimation is limited to the factors involved.

Also, in the case where a model is used that specifies causal causes, having machine learned behavior under normal conditions from only normal data, normal data need only be collected, and thus data collection is easy. However, since there is no information relating to the target system at the time of anomalies, it is difficult to estimate the component that is the root cause of an anomaly.

Through such a process, the inventor identified the problem of estimating the component that is the root cause of an anomaly using normal data that can be easily collected, and also derived means for solving this problem.

That is, in order to estimate the component that is the root cause of an anomaly using only normal data, the inventor (a) estimated the likelihood of the anomaly propagating between components, and (b) derived means for estimating the component that is the root cause based on the likelihood of the anomaly propagating.

Hereinafter, an example embodiment will be described with reference to the drawings. Note that, in the drawings described below, the same reference numerals may be given to elements having the same functions or corresponding functions, and redundant description thereof may also be omitted.

### Example Embodiment

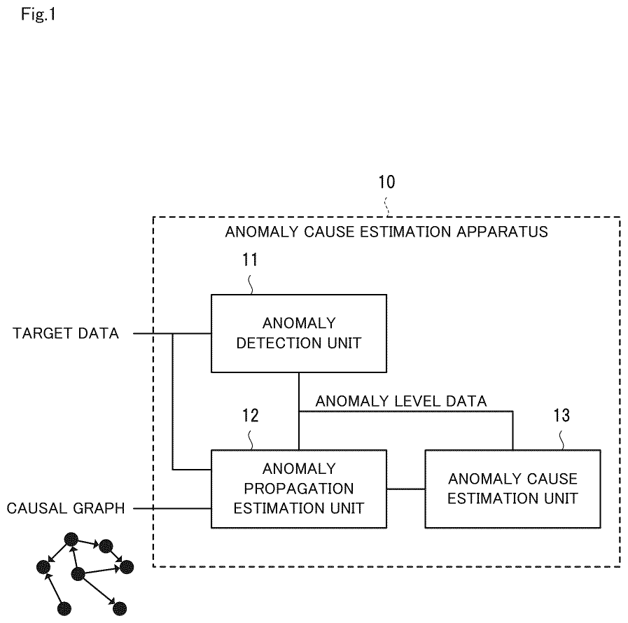

The configuration of an anomaly cause estimation apparatus 10 in the example embodiment will be described, using FIG. 1. FIG. 1 is a diagram for describing an example of the anomaly cause estimation apparatus.

### Apparatus Configuration

When an anomaly is detected in a target system, the anomaly estimation apparatus 10 (a) estimates the degree to which an anomaly of a component Si is conveyed to another component Sj that is causally related to the component Si (likelihood of the anomaly propagating between components), and (b) estimates the component that is the root cause of the detected anomaly, based on the estimated likelihood of the anomaly propagating between the components. Note that i and j are different positive integers.

The target system is a system that utilizes an OT/IoT network or the like. The target system is, for example, a system that is used in power plants, traffic facilities, factories, planes, cars, home appliances and the like, and has a plurality of components.

The components are, for example, devices such as sensors and actuators provided in the target system. Also, the components output signals or information indicating pressure, flow rate, temperature, voltage, current and the like, for example.

The anomaly cause estimation apparatus 10 includes an anomaly detection unit 11, an anomaly propagation estimation unit 12 and an anomaly cause estimation unit 13.

The anomaly detection unit 11 converts a data series acquired in a time series from the plurality of components that are provided in the target system into an anomaly level data series, and detects an anomaly based on the obtained anomaly level data series.

Specifically, first, the anomaly detection unit 11 converts the data series into an anomaly level data series, using a given anomaly detector (anomaly detection algorithm).

The data series is information obtained by measurement values measured by the respective components being enumerated in a time series. The anomaly level data series is information obtained by the measurement values of the data series being converted into anomaly levels using the anomaly detector.

An anomaly level is a value indicating the degree to which the measurement value measured by the component at a certain point in time is anomalous. The point in time can be represented by year/month/date/time, for example.

The anomaly detector is able to use upper and lower limit thresholds, difference from a system model, a regression prediction residual method, an autoencoder, a support vector machine, probability process regression, density estimation, density ratio estimation, invariant analysis, and the like, for example.

The anomaly detector may, however, not only output an anomaly level data series for each component but may output one anomaly level data series for a plurality of components. In such a case, the one anomaly level data series is converted into anomaly level data series for each component, using a technique such as factorial analysis, correlation analysis or factor analysis. For example, conversion is performed using multiple regression analysis, L1 sparse regression, PCA (Principal Correlation Analysis), LIME (Local Interpretable Model-agnostic Explainations), an attention mechanism or the like.

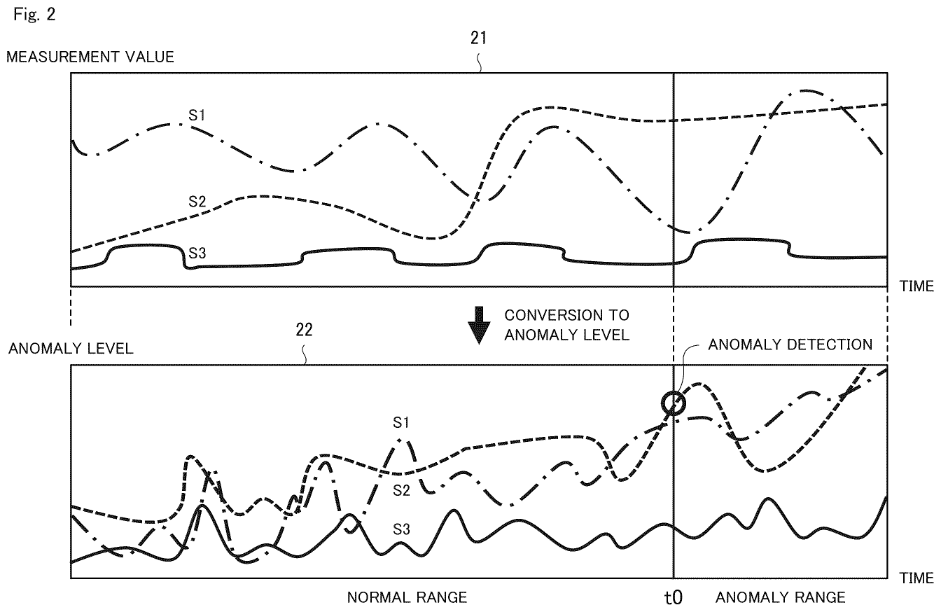

FIG. 2 is a diagram for describing an example of conversion to an anomaly level data series. Graph 21 in FIG. 2 shows a data series of each of components S1, S2 and S3. Note that the data series of the component S1 is represented by a one dot chain line, the data series of the component S2 is represented by a dashed line, and the data series of the component S3 is represented by a solid line.

Graph 22 in FIG. 2 shows an anomaly level data series of each of the components S1, S2, and S3. Note that the anomaly level data series of the component Si is represented by a one dot chain line, the anomaly level data series of component S2 is represented by a dashed line, and the anomaly level data series of component S3 is represented by a solid line.

Next, the anomaly detection unit 11 detects an anomaly when the anomaly level of the anomaly level data series becomes greater than or equal to a threshold set in advance.

In the example in FIG. 2, at time t0 at which an anomaly is detected, the anomaly detection unit 11 detects the anomaly, because the anomaly level of the anomaly level data series (dashed line) of the component S2 has become greater than or equal to the threshold set in advance.

The anomaly propagation estimation unit 12 inputs an anomaly level data series (target anomaly level data series), extracted from the anomaly level data series, to be used for estimating the likelihood of the anomaly propagating, a data series (target data series) corresponding to the target anomaly level data series and information into an anomaly propagation estimation model, and estimates the likelihood of the anomaly propagating (anomaly propagation likelihood) between components.

Normal data is easy to collect, but since normal data does not include information relating to the target system at the time of anomalies, the component that is the root cause of an anomaly cannot be estimated with a model trained using only normal data as described above.

In view of this, a model for estimating the likelihood of an anomaly propagating between components is generated, with normal data, the anomaly level of the normal data and minimal information as learning data.

The target anomaly level data series is an anomaly level data series for a period that is used in order to estimate the likelihood of an anomaly propagating, that is, a period from the point in time at which the anomaly is detected to a point in time set in advance. The target data series is the data series of a period corresponding to the target anomaly level data series.

The minimal information is a directed graph (causal graph) that represents the causal relationship between components. The causal graph is, for example, information that uses 0 and 1 to indicate whether or not there is a direct causal relationship from the component Si to the component Sj.

That is, the causal graph shows that, if there is a causal relationship between components, a change in the measurement value of one component affects the measurement value of the other component in the causal relationship. Note that the causal graph can be represented by an adjacency matrix, for example.

The anomaly propagation estimation model is generated by machine learning, with a normal data series acquired in a time series from the plurality of components, an anomaly level data series for use in learning obtained by converting the normal data series, and minimal information as learning data in the learning.

The anomaly propagation estimation model is a model that estimates the likelihood of an anomaly propagating from the component Si to the component Sj at various points in time in the anomaly cause estimation.

Propagation of an anomaly will now be described.

Because the anomaly level in an anomalous state tends to be higher than the anomaly level in a normal state, the likelihood of the component Sj becoming anomalous when the component Si has become anomalous can be calculated, by comparing the increase in the anomaly level of the component Si with the increase in the anomaly level of the component Sj that is causally affected by the component Si.

When comparing the increase in the anomaly levels, derivative coefficients are calculated, using a model such as linear regression, kernel regression or a neural network. There is, however, a large variation in the calculated derivative coefficients, and thus the degree to which an anomaly propagates robustly may be calculated by sampling the variables and anomaly levels and performing numerical differentiation using regression, multiple regression or the like.

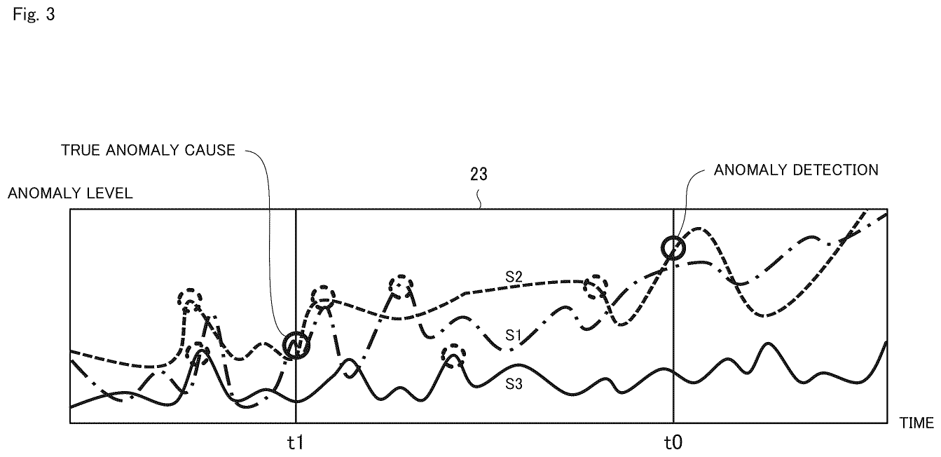

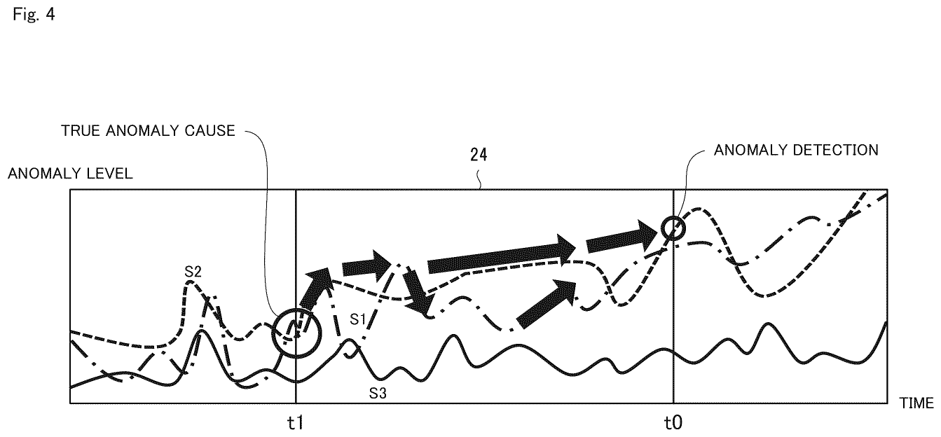

FIGS. 3 and 4 are diagrams for describing an example of propagation of an anomaly. In FIGS. 3 and 4, the anomaly detection unit 11 determines that the period before time t0 at which an anomaly is detected is a normal state, but the cause of the anomaly actually exists from before time t0.

Graph 23 in FIG. 3 shows that the anomaly detection unit 11 detected an anomaly at time to, assuming the true anomaly cause occurred at time t1. There are, however, multiple candidates for the true anomaly cause, as indicated by the dashed circles in graph 23 in FIG. 3.

Also, graph 24 in FIG. 4 shows propagation (arrows) of the anomaly from the true anomaly cause at time t1 to the time at which the anomaly is detected at time t0. Note that there are multiple anomaly propagation scenarios (scenario: path through which an anomaly propagates from true anomaly cause to anomaly detection).

Estimation of the likelihood of an anomaly propagating will now be described.

In the example in FIG. 4, the true anomaly cause is included in the period of the normal state (period from time t0 to time t1). Also, the anomaly level varies even in the normal state.

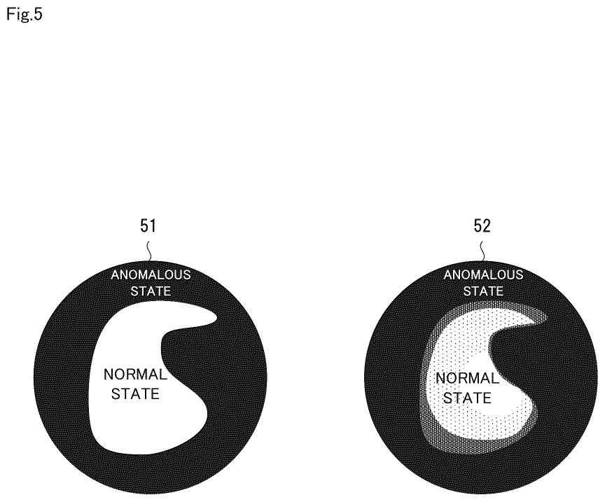

FIG. 5 is a diagram for describing the anomaly level in normal data. Conventionally, as in a variable space 51 shown in FIG. 5, the variable space corresponding to the component Si represents the normal state and the anomalous state of data with binary information (e.g., 0 or 1).

However, the anomaly level varies even in normal data as described above. Accordingly, as in a variable space 52 shown in FIG. 5, there are also a plurality of states in the normal state, and thus the distance (closeness) between the normal state and the anomalous state changes.

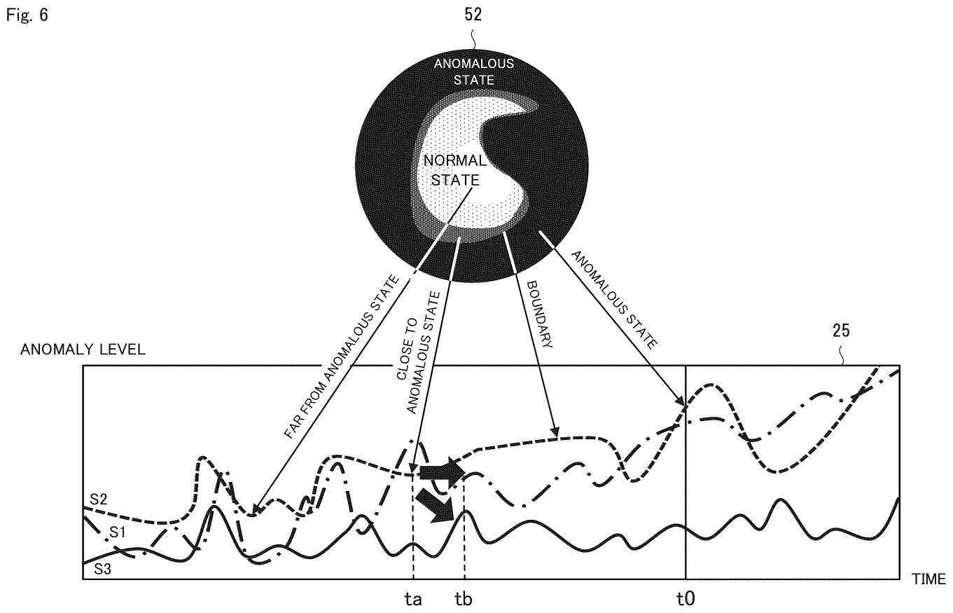

FIG. 6 is a diagram for describing the relationship between the variable space and the anomaly level data series. As shown in FIG. 6, the anomaly level data series of graph 25 is an indicator representing the distance between the normal state and the anomalous state in the variable space 52. Accordingly, by using the ratio of change in anomaly level between components, an indicator representing how closely another component approaches the anomalous state when one component approaches the anomalous state, that is, the likelihood of the anomaly propagating, can be estimated.

Also, in the example in FIG. 6, the anomaly of the component S2 (dashed line) at time ta is shown to propagate (arrows) to the components S1 and S3 at time tb.

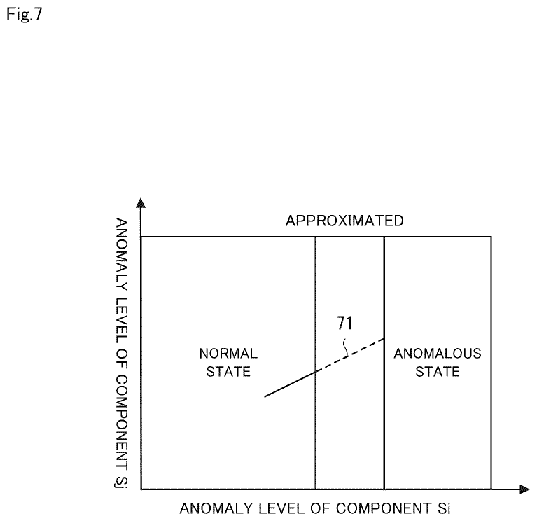

FIG. 7 is a diagram for describing the relationship of the anomaly levels between components. When the component Si in the normal state approaches the anomalous state as shown in FIG. 7, the degree to which the component Sj in the normal state approaches the anomalous state (anomaly propagation likelihood) can be estimated (approximated) using a linear regression trend 71. The example in FIG. 7 uses a linear regression trend, but the invention is not limited thereto.

As an example, the likelihood of the anomaly propagating from Si to Sj may be estimated as Δ×Ai/Aj, where Ai is the average anomaly level of Si in the normal state, Aj is the average anomaly level of Sj in the normal state, and Δ is the slope obtained as a coefficient of linear regression.

In this way, the anomaly propagation estimation unit 12 estimates the anomaly propagation likelihood between components at various points in time. Accordingly, the true cause of the anomaly can be estimated, based on the anomaly propagation likelihood.

The anomaly estimation unit 13 inputs an anomaly level data series to be targeted (target anomaly level data series) and the anomaly propagation likelihood for each predetermined time period to an anomaly cause estimation model, estimates the cause of the anomaly that occurred, and outputs anomaly cause information indicating the estimated cause.

The anomaly cause estimation model evaluates the overall consistency obtained using the consistency between the anomaly level data series and an anomaly propagation scenario and the likelihood of the anomaly propagation scenario itself holding true which is based on the anomaly propagation likelihood. Normal logical inference, parameter estimation using a propagation/diffusion model, Bayesian inference, a Bayesian network and the like, for example, can be used as the anomaly cause estimation model.

In the case of using Bayesian inference and a Bayesian network, use of an approximate inference algorithm such as belief propagation or expectation propagation enables the amount of calculation to be reduced, due to not needing to comprehensively search for all patterns relating to the anomalous state.

Also, in the case of using Bayesian inference and a Bayesian network, additional information such as “this component is not the cause of the anomaly” can be accepted, and even missing anomaly levels is not an issue.

Specifically, first, the anomaly estimation unit 13 infers a point in time and component with respect to which the anomaly occurred, so as to be consistent with the target anomaly level data series, using the target anomaly level data series and the anomaly propagation likelihood.

That is, although the anomaly level can be measured by the anomaly detection unit 11, the anomalous state is unknown (it is not known whether the state is anomalous or normal at each point in time). In view of this, the way in which the anomaly propagates defines the connection condition between unknown anomalous states. Evaluation of which component was the true anomaly cause at what point in time and which component was truly normal at what point in time is performed with as many patterns as possible to enhance the consistency of the scenario with the anomaly level data series.

For example, by postulating a scenario that an anomaly (cause) occurred in a certain component at a certain point in time and that the anomaly propagated according to the estimated anomaly propagation likelihood as described above, there is a high possibility that the scenario actually progressed, provided the measured anomaly level data series can be accurately reproduced (adjusted). In that case, it is natural to estimate the anomaly occurrence location postulated in the scenario as the anomaly cause. However, if the measured anomaly level series cannot be accurately reproduced with such a scenario, the possibility arises that the anomaly actually propagated in line with another scenario.

It is also possible to postulate that the anomaly (cause) occurred in another component at another point in time. It is also possible to postulate that the anomaly (cause) occurred in a plurality of components at the same time, and it can also be postulated that the anomaly (cause) occurred in a plurality of components at different times. However, the possibility of a scenario with multiple anomaly causes holding true is low.

Furthermore, with regard to the propagation of the anomaly, it can be postulated that the anomaly propagated against the estimated anomaly propagation likelihood. It can also be postulated that the anomaly actually propagated, despite the estimated anomaly propagation likelihood being low, or, conversely, that the anomaly did not actually propagate despite the estimated anomaly propagation likelihood being high. However, the possibility that a scenario in which the anomaly propagates contrary to the estimated anomaly propagation likelihood held true is low.

Among various scenarios such as described above, there is a pattern that is able to more accurately reproduce the measured anomaly level data series. If a scenario is highly feasible and the measured anomaly level data series can be accurately reproduced by the scenario, the scenario is considered to have a high overall consistency with the anomaly level data series. Accordingly, the occurrence of the anomaly postulated in the scenario can be estimated as the anomaly cause.

For example, the scenarios of all possible patterns are enumerated, and the possibility of a scenario holding true can be evaluated based on the frequency of the postulated anomaly and anomaly propagation likelihood, whereas the accuracy with which the scenario reproduces the anomaly level series can be evaluated based on the reproduction error. A pattern in which both of these indicators are large values exceeding the threshold, a pattern in which the sum of these indicators is the largest, or the like can then be specified as a realized scenario and the anomaly cause can be estimated.

Alternatively, by weighting the anomaly cause of various patterns based on the above-described indicators, the degree to which a component is the anomaly cause can be estimated while superimposing various scenarios that are highly consistent with the measured anomaly level series.

For example, in the case of using Bayesian inference and a Bayesian network, the degree to which a component is the anomaly cause can be calculated as a posterior probability. Furthermore, as described above, the overall consistency can be evaluated while scenarios are probabilistically superimposed without actually enumerating all scenarios, thus enabling the amount of computation to be reduced. Furthermore, in the case of using an approximate inference algorithm, the amount of computation can be further reduced.

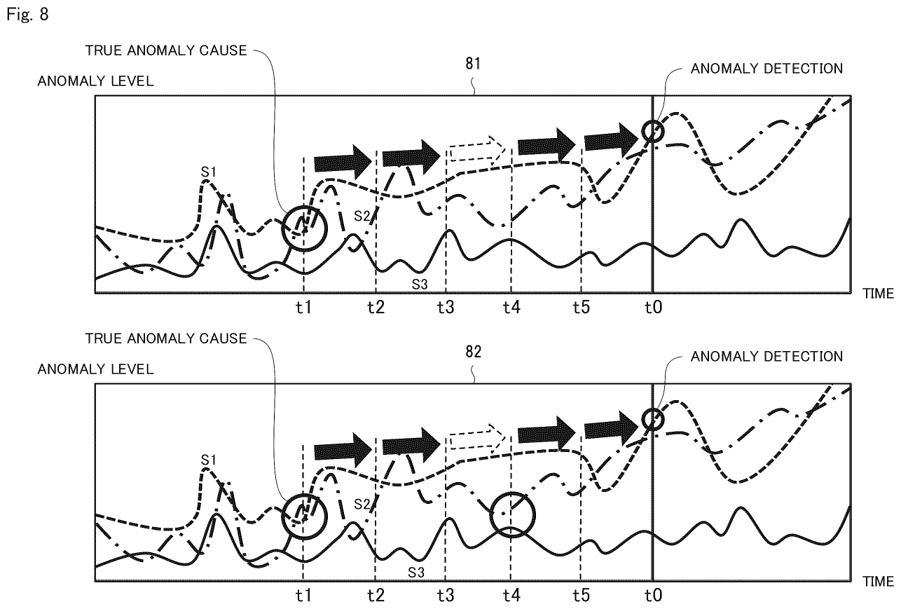

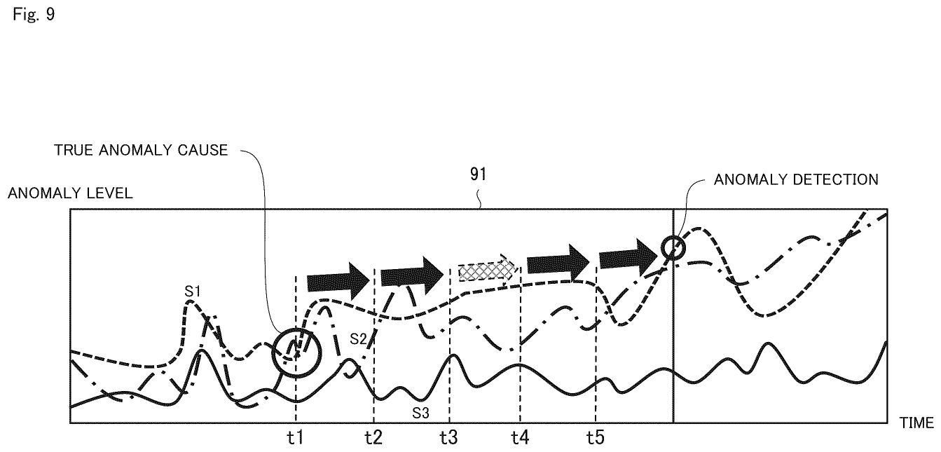

FIGS. 8 and 9 are diagrams for describing overall inference of the anomaly cause. Evaluation of patterns such as shown in FIGS. 8 and 9, for example, will be described.

The solid arrows in FIGS. 8 and 9 indicate the case where the anomaly propagation likelihood is high. The dashed arrows indicate the case where the anomaly propagation likelihood is low.

Graphs 81, 82 and 91 in FIGS. 8 and 9 all show situations in which the anomaly propagation likelihood is low between times t3 and t4, and the anomaly propagation likelihood is high at other times. However, the scenarios that are postulated in graphs 81, 82 and 91 differ. Depending on the postulated scenario, the consistency of the scenario with the anomaly level series differs, and the possibility of the scenario holding true also differs.

The pattern of graph 81 in FIG. 8 shows propagation for each predetermined time period, assuming the true anomaly cause occurred at time t1. The simplest method for estimating the cause is, for example, to postulate a scenario that propagation is present when the anomaly propagation likelihood is a threshold anomaly set in advance, and that propagation is absent when the anomaly propagation likelihood is less than the threshold. An attempt is then made to estimate the cause while tracing back through the arrows indicating that propagation is present. Such a scenario can be said to be a natural assumption.

In the case of graph 81, on the path (propagation path) that joins the arrows from the postulated true anomaly cause to the time at which the anomaly is detected, propagation is estimated to be absent in the period between time t3 and time t4, and thus propagation is interrupted.

On the propagation path of graph 81, propagation is interrupted at an intermediate position, and thus the anomaly is not propagated beyond that point. Given that the measured anomaly level continues to increase after time t4 despite propagation being interrupted, this scenario is not consistent with the target anomaly level data series (consistency is low). However, given that graph 81 is a scenario that is based on the natural assumption that propagation is present or absent in accordance with the anomaly propagation likelihood, the possibility of the scenario itself holding true is high.

In the pattern of graph 82 in FIG. 8, on the path (propagation path) that joins the arrows from the postulated true anomaly cause to the time at which the anomaly is detected, assuming the true anomaly cause occurred at times t1 and t4, propagation is estimated to be absent between times t3 and t4, but two true anomaly causes are postulated.

On the propagation path in graph 82, propagation appears to be interrupted at an intermediate position, but because two true anomaly causes are postulated, this scenario is consistent with the target anomaly level data series, due to the assumption that the increase in the anomaly level in the first half is brought about by a first anomaly cause and the increase in the anomaly level in the second half is brought about by a second anomaly cause. However, the possibility of there being two postulated true anomaly causes in the target system is low, and thus the possibility that this scenario actually held true is low.

As evident from the two examples shown using FIG. 8, in the simple method described above, scenarios are postulated that the anomaly does not propagate if the anomaly propagation likelihood is lower than the threshold, and thus the cause cannot be estimated by tracing back further, in the case where the anomaly propagation likelihood is erroneously set low, despite the anomaly actually propagating.

In other words, if there is even one large error when calculating the anomaly propagation likelihood, the correct cause can no longer be estimated. Accordingly, even if the anomaly propagation likelihood is low, it is desirable to estimate the most reasonable scenario by also postulating a pattern in which the anomaly propagates.

In that case, a scenario that postulates that the anomaly propagated, despite the anomaly propagation likelihood being low (equivalent to the case where propagation is absent described above) retains an assumption with a low possibility of holding true.

In summary, it is evident that the cause of an anomaly needs to be estimated by comprehensively taking account of both the consistency of the postulated scenario with the target anomaly level data series and the possibility of the scenario itself holding true (i.e., whether the scenario is based on an unreasonable assumption).

The pattern of graph 91 in FIG. 9 shows propagation for each predetermined time period, assuming the true anomaly cause occurred at time t1. In the case of graph 91, at first glance, the propagation path from the postulated true anomaly cause to the time at which the anomaly is detected appears to be interrupted.

However, when a scenario is postulated that the anomaly actually propagated between t3 and t4 in graph 91 even though the anomaly propagation likelihood is low (when local errors are absorbed on the basis that the scenario is consistent with the anomaly level data series), this scenario that includes the shaded dashed arrow is consistent with the target anomaly level data series. Accordingly, by postulating against the anomaly propagation likelihood, the likelihood of this scenario being consistent with the anomaly level data series increases. On the other hand, postulating contrary to the anomaly propagation likelihood is this way reduces the possibility of this scenario holding true.

Comparing graphs 81, 82 and 91, graph 81 postulates that the anomaly does not propagate where the anomaly propagation likelihood is low, which is a reasonable assumption, and the possibility of this scenario holding true is high. However, given that the measurement value of the anomaly level increases even after time t3 at which the anomaly is no longer expected to propagate, the consistency of the scenario with the target anomaly level data series is extremely low.

Graph 82 postulates that a second anomaly cause appeared after the anomaly propagation was initially interrupted. The scenario that two anomaly causes occurred independently is unreasonable and the possibility of this scenario holding true is low. Conversely, by joining the propagations of the anomalies that result from the two anomaly causes, there is a high likelihood that the scenario leading to anomaly detection will be realized.

Graph 91 postulates that the anomaly propagated, despite the anomaly propagation likelihood being low. Compared to graph 81, the possibility of the scenario of graph 91 that requires such an assumption holding true is low. However, compared to a scenario in which two anomaly causes occur independently, such as in graph 82, the possibility of the scenario of graph 91 holding true is relatively high. Also, graphs 82 and 91 are highly consistent with the target anomaly level data series, as described above.

Accordingly, the anomaly estimation unit 13 selects the most reasonable scenario as the true anomaly cause of the anomaly that occurred. The selection criteria depend on the consistency between the scenario and the target anomaly level data series and the possibility of the scenario holding true both being high, the sum thereof being larger than the other scenarios (overall consistency), or the like.

Accordingly, the anomaly estimation unit 13 selects the scenario of graph 91 as the true anomaly cause of the anomaly that occurred. The reason for selecting this scenario is that the consistency between the scenario of graph 81 and the target anomaly level data series is extremely low, and thus, even if the possibility of the scenario of graph 91 holding true is low, the overall consistency of the scenario of graph 91 is higher than graph 81. Similarly, compared to the scenario of graph 82, the overall consistency of graph 91 is higher, given that the possibility of the scenario of graph 91 holding true is higher than the scenario of graph 81, even though the consistencies of both scenarios with the target anomaly level data series are comparable. Accordingly, the true anomaly cause is estimated to have occurred at time t1 in the scenario shown in graph 91.

Note that, in the examples of FIGS. 8 and 9, the true anomaly cause is estimated with three scenarios, but the true anomaly cause is actually estimated by evaluating the scenarios of various patterns.

Furthermore, in addition to selecting one scenario of the most reasonable pattern from various patterns, the true anomaly cause can be estimated as a posterior probability from the probabilistic superposition of the scenarios of various patterns, according to Bayesian inference or the like. In that case, the estimated anomaly cause takes a probability value. Additionally, the anomaly cause can also be estimated with accuracy, by summing a plurality of main scenarios.

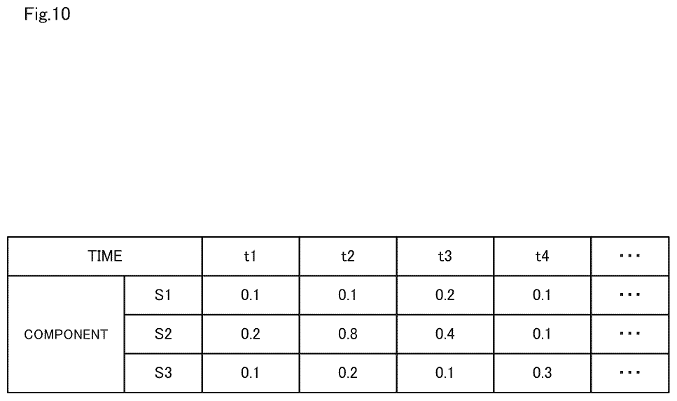

Next, the anomaly estimation unit 13 outputs anomaly cause information indicating the estimated cause. FIG. 10 is a diagram for describing an example of anomaly cause information. The anomaly cause information shown in FIG. 10 indicates the likelihood of each of the components being the anomaly cause at predetermined times t1, t2, t3, t4, and so on. The points in time are indicated by date-time, for example.

Also, the anomaly cause information may, for example, indicate the point in time at which the true anomaly cause occurred and the component that is the true anomaly cause. Also, candidates of the path through which the anomaly propagated may be output.

### [System Configuration]

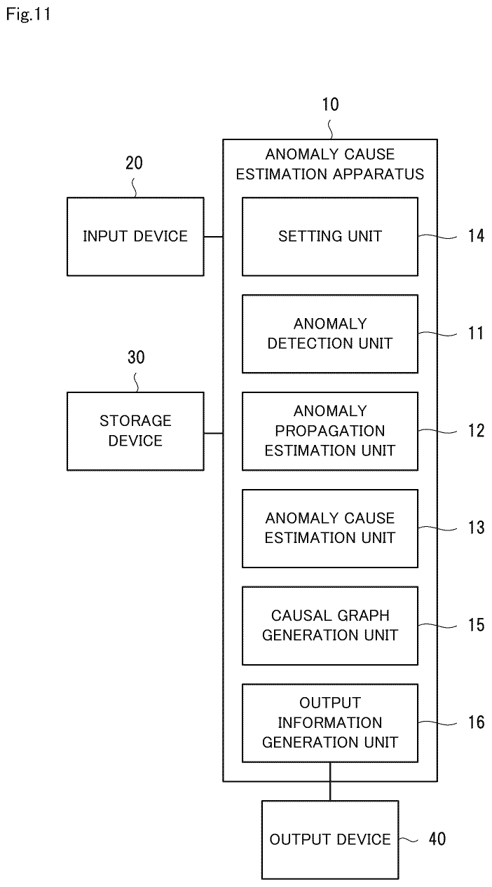

The configuration of the anomaly cause estimation apparatus 10 in the example embodiment will now be described more specifically. FIG. 11 is a diagram for describing an example of a system having the anomaly cause estimation apparatus.

As shown in FIG. 11, the system in the example embodiment includes the anomaly cause estimation apparatus 10, an input device 20, a storage device 30 and an output device 40. Note that the anomaly cause estimation apparatus 10, the input device 20, the storage device 30 and the output device 40 may be connected via a network.

The anomaly cause estimation apparatus 10 is, for example, a CPU (Central Processing Unit), or a programmable device such as an FPGA (Field-Programmable Gate Array), or a GPU (Graphics Processing Unit), or an information processing apparatus such as a circuit, a server computer, a personal computer or a mobile terminal equipped with one or more of the above.

The input device 20 is a device for inputting data to the anomaly cause estimation apparatus 10. The input device 20 is, for example, a keyboard, a mouse or a touch panel. Note that, in the example in FIG. 11, the input device 20 is provided outside the anomaly cause estimation apparatus 10, but may be provided internally.

The storage device 30 stores data series, anomaly level data series, an anomaly propagation estimation model, an anomaly propagation estimation model, anomaly cause information, setting data and the like, for example. The storage device 30 is, for example, a database or a server computer. Note that, in the example in FIG. 11, the storage device 30 is provided outside the anomaly cause estimation apparatus 10, but may be provided internally. Also, the storage device 30 may be divided into a plurality of storage devices.

The output device 40 acquires output information described later that has been converted by an output information generation unit 16 into a format that can be output, and outputs generated images, audio and the like, based on the output information. The output device 40 is, for example, an image display device that uses liquid crystals, organic EL (Electro Luminescence) or CRTs (Cathode Ray Tubes). Furthermore, the image display device may include an audio output device such as a speaker. Note that the output device 40 may also be a printing device such as a printer.

The anomaly cause estimation apparatus will now be specifically described.

The anomaly cause estimation apparatus 10 has the anomaly detection unit 11, the anomaly propagation estimation unit 12, the anomaly cause estimation unit 13, a setting unit 14, a causal graph generation unit 15 and the output information generation unit 16.

Note that the anomaly detection unit 11, the anomaly propagation estimation unit 12 and the anomaly estimation unit 13 have already been described, and description thereof will thus be omitted.

The setting unit 14 sets a period for estimating the anomaly cause before the point in time at which the anomaly is detected. Also, the setting unit 14 configures settings necessary for estimating the anomaly cause.

The causal graph generation unit 15 generates causal graphs from normal data. The causal graph generation unit 15 generates causal graphs, using logistic regression, PCA, causal effect estimation, the PC algorithm, the TPDA (Three Phase Dependency Analysis) algorithm, Bayesian inference, information criterion, transfer entropy, Granger causality, a structural equation, LiNGAM (Linear Non-Gaussian Acyclic Model) or the like, for example.

The output information generation unit 16 generates output information by converting anomaly cause information into a format that can be output to the output device 40, and outputs the generated output information to the output device 40.

Note that the output information generation unit 16 may also cause the output device 40 to perform ranking display of the probabilities of the components being the anomaly cause in descending order. Also, the output information generation unit 16 may cause the output device 40 to display the component specified as the true anomaly cause and a recovery procedure. Furthermore, the output information generation unit 16 may cause the output device 40 to display the propagation path or the like.

### [Apparatus Operations]

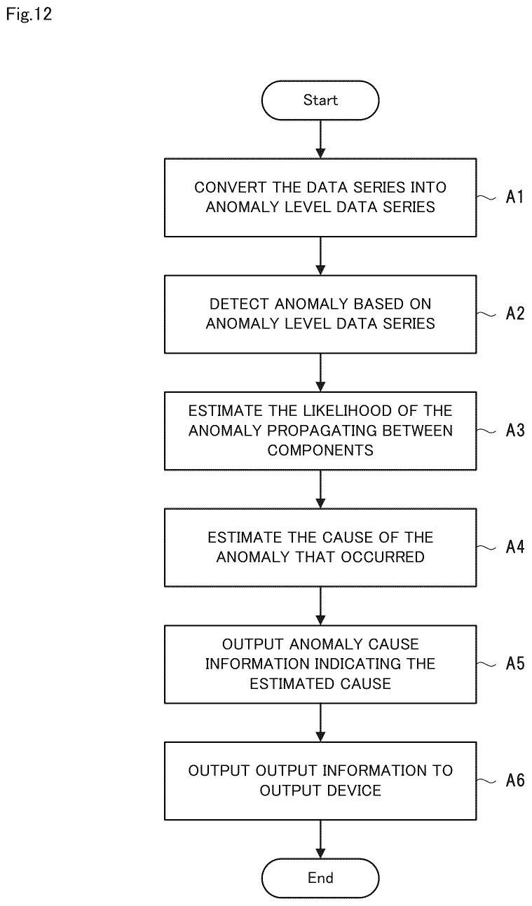

Operations of the anomaly cause estimation apparatus in the example embodiment will now be described using FIG. 12. FIG. 12 is a diagram for describing an example of the operations of the anomaly cause estimation apparatus. In the following description, the diagram will be referred to as appropriate. Also, in the example embodiment, an anomaly cause estimation method is implemented by operating the anomaly cause estimation apparatus. Therefore, the following description of the operations of the anomaly cause estimation apparatus will be given in place of a description of the anomaly cause estimation method in the example embodiment.

Initially, the anomaly detection unit 11 converts a data series acquired in a time series from the plurality of components provided in the target system into an anomaly level data series (step A1). Next, the anomaly detection unit 11 detects an anomaly based on the obtained anomaly level data series (step A2).

Next, the anomaly propagation estimation unit 12 inputs an anomaly level data series to be targeted (target anomaly level data series) that is extracted from the anomaly level data series for use in estimating the likelihood of the anomaly propagating, a data series (target data series) corresponding to the target anomaly level data series, and minimal information (causal graph) to the anomaly propagation estimation model, and estimates the likelihood of the anomaly propagating between components (anomaly propagation likelihood) (step A3).

Next, the anomaly estimation unit 13 inputs the anomaly level data series to be targeted (target anomaly level data series) and the anomaly propagation likelihood to the anomaly cause estimation model and estimates the cause of the anomaly that occurred (step A4).

Next, the anomaly estimation unit 13 outputs anomaly cause information indicating the estimated cause (step A5). Next, the output information generation unit 16 generates output information by converting the anomaly cause information into a format that can be output to the output device 40, and outputs the generated output information to the output device 40 (step A6).

### Effects of Example Embodiment

According to the example embodiment, costs can be kept down by constructing a model that causally infers the true anomaly cause, using only normal data and minimal design knowledge (causal graph).

Because the true anomaly cause can be specified, prompt action can be taken when an anomaly is detected.

By utilizing small changes in the anomaly level, an anomaly propagation likelihood estimation model for estimating the likelihood of an anomaly propagating can be constructed even from normal data. At that time, errors can be suppressed by robustly estimating the degree of propagation with the anomaly propagation likelihood estimation model.

By integrating information including ambiguous continuous values that contain errors, such as the anomaly level and the anomaly propagation likelihood, the true anomaly cause that does not appear in the anomaly level can be specified. Even if there are omissions in the anomaly levels, the true anomaly cause can be estimated by taking the omissions into consideration.

### [Program]

The program according to the example embodiment may be a program that causes a computer to execute steps A1 to A6 shown in FIG. 12. By installing this program in a computer and executing the program, the anomaly cause estimation apparatus and the anomaly cause estimation method according to the present example embodiment can be realized. Further, the processor of the computer performs processing to function as the anomaly detection unit 11, the anomaly propagation estimation unit 12, the anomaly cause estimation unit 13, a setting unit 14, a causal graph generation unit 15 and the output information generation unit 16.

Also, the program according to the example embodiment may be executed by a computer system constructed by a plurality of computers. In this case, for example, each computer may function as any of the anomaly detection unit 11, the anomaly propagation estimation unit 12, the anomaly cause estimation unit 13, a setting unit 14, a causal graph generation unit 15 and the output information generation unit 16.

### [Physical Configuration]

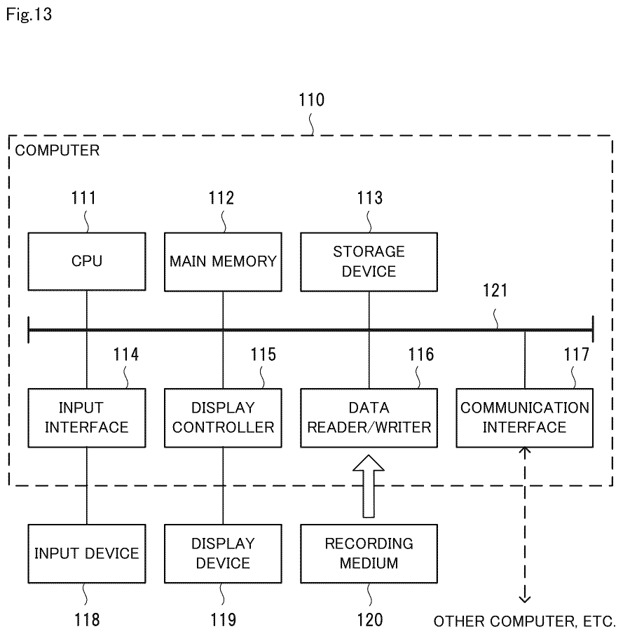

Here, a computer that realizes the learning apparatus and the anomaly detection apparatus by executing the program according to the example embodiment will be described with reference to FIG. 13. FIG. 13 is a diagram for describing an example of a computer that realizes the anomaly cause estimation apparatus.

As shown in FIG. 13, a computer 110 includes a CPU (Central Processing Unit) 111, a main memory 112, a storage device 113, an input interface 114, a display controller 115, a data reader/writer 116, and a communications interface 117. These units are each connected so as to be capable of performing data communications with each other through a bus 121. Note that the computer 110 may include a GPU (Graphics Processing Unit) or an FPGA (Field-Programmable Gate Array) in addition to the CPU 111 or in place of the CPU 111.

The CPU 111 opens the program (code) according to this example embodiment, which has been stored in the storage device 113, in the main memory 112 and performs various operations by executing the program in a predetermined order. The main memory 112 is typically a volatile storage device such as a DRAM (Dynamic Random Access Memory). Also, the program according to this example embodiment is provided in a state being stored in a computer-readable recording medium 120. Note that the program according to this example embodiment may be distributed on the Internet, which is connected through the communications interface 117. Note that the computer-readable recording medium 120 is a non-volatile recording medium.

Also, other than a hard disk drive, a semiconductor storage device such as a flash memory can be given as a specific example of the storage device 113. The input interface 114 mediates data transmission between the CPU 111 and an input device 118, which may be a keyboard or mouse. The display controller 115 is connected to a display device 119, and controls display on the display device 119.

The data reader/writer 116 mediates data transmission between the CPU 111 and the recording medium 120, and executes reading of a program from the recording medium 120 and writing of processing results in the computer 110 to the recording medium 120. The communications interface 117 mediates data transmission between the CPU 111 and other computers.

Also, general-purpose semiconductor storage devices such as CF (Compact Flash (registered trademark)) and SD (Secure Digital), a magnetic recording medium such as a Flexible Disk, or an optical recording medium such as a CD-ROM (Compact Disk Read-Only Memory) can be given as specific examples of the recording medium 120.

Also, instead of a computer in which a program is installed, the anomaly cause estimation apparatus 10 according to this example embodiment can also be realized by using hardware corresponding to each unit. Furthermore, a portion of the anomaly cause estimation apparatus 10 may be realized by a program, and the remaining portion realized by hardware.

### SUPPLEMENTARY NOTE

Furthermore, the following supplementary notes are disclosed regarding the example embodiments described above. Some portion or all of the example embodiments described above can be realized according to (supplementary note 1) to (supplementary note 18) described below, but the below description does not limit the present invention.

### Supplementary Note 1

An anomaly cause estimation apparatus comprising:
an anomaly detection unit that converts a data series acquired in a time series from a plurality of components provided in a target system into an anomaly level data series, and detects an anomaly based on the obtained anomaly level data series; and
an anomaly propagation estimation unit that inputs a target anomaly level data series, extracted from the anomaly level data series, for a period before a point in time at which the anomaly is detected, a target data series corresponding to the target anomaly level data series, and information indicating a causal relationship between the components to an anomaly propagation estimation model, and estimates an anomaly propagation likelihood of the anomaly propagating between the components.

### Supplementary Note 2

The anomaly cause estimation apparatus according to supplementary note 1,
wherein the anomaly propagation estimation model is generated by machine learning, with a normal data series acquired in a time series from the plurality of the components, an anomaly level data series for use in learning obtained by converting the normal data series using the anomaly detection means, and the information as learning data in the learning.

### Supplementary Note 3

The anomaly cause estimation apparatus according to supplementary note 2,
wherein the information is a causal graph generated using the normal data series.

### Supplementary Note 4

The anomaly cause estimation apparatus according to any one of supplementary notes 1 to 3, further comprising:
an anomaly cause estimation unit that inputs the anomaly level data series and the anomaly propagation likelihood to an anomaly cause estimation model, estimates a cause of the anomaly that occurred, and outputs anomaly cause information indicating the estimated cause.

### Supplementary Note 5

The anomaly cause estimation apparatus according to supplementary note 4,
wherein the anomaly cause estimation model evaluates an overall consistency obtained using a consistency between the anomaly level data series and an anomaly propagation scenario and a likelihood of the anomaly propagation scenario holding true which is based on the anomaly propagation likelihood.

### Supplementary Note 6

The anomaly cause estimation apparatus according to supplementary note 4 or 5,
wherein the anomaly cause information is a likelihood of each of the components being the anomaly cause at a predetermined point in time.

### Supplementary Note 7

An anomaly cause estimation method comprising:
a step of converting a data series acquired in a time series from a plurality of components provided in a target system into an anomaly level data series;
a step of detecting an anomaly based on the obtained anomaly level data series; and
a step of inputting a target anomaly level data series, extracted from the anomaly level data series, for a period before a point in time at which the anomaly is detected, a target data series corresponding to the target anomaly level data series, and information indicating a causal relationship between the components to an anomaly propagation estimation model, and estimating an anomaly propagation likelihood of the anomaly propagating between the components.

### Supplementary Note 8

The anomaly cause estimation method according to supplementary note 7,
wherein the anomaly propagation estimation model is generated by machine learning, with a normal data series acquired in a time series from the plurality of the components, an anomaly level data series for use in learning obtained by converting the normal data series, and the information as learning data in the learning.

### Supplementary Note 9

The anomaly cause estimation method according to supplementary note 8,
wherein the information is a causal graph generated using the normal data series.

### Supplementary Note 10

The anomaly cause estimation method according to any one of supplementary notes 7 to 9, further comprising:
a step of inputting the anomaly level data series and the anomaly propagation likelihood to an anomaly cause estimation model, estimating a cause of the anomaly that occurred, and outputting anomaly cause information indicating the estimated cause.

### Supplementary Note 11

The anomaly cause estimation method according to supplementary note 10,
wherein the anomaly cause estimation model evaluates an overall consistency obtained using a consistency between the anomaly level data series and an anomaly propagation scenario and a likelihood of the anomaly propagation scenario holding true which is based on the anomaly propagation likelihood.

### Supplementary Note 12

The anomaly cause estimation method according to supplementary note 10 or 11,
wherein the anomaly cause information is a likelihood of each of the components being the anomaly cause at a predetermined point in time.

### Supplementary Note 13

A computer-readable recording medium that includes a program recorded thereon, the program including instructions that cause a computer to carry out:
a step of converting a data series acquired in a time series from a plurality of components provided in a target system into an anomaly level data series;
a step of detecting an anomaly based on the obtained anomaly level data series; and
a step of inputting a target anomaly level data series, extracted from the anomaly level data series, for a period before a point in time at which the anomaly is detected, a target data series corresponding to the target anomaly level data series, and information indicating a causal relationship between the components to an anomaly propagation estimation model, and estimating an anomaly propagation likelihood of the anomaly propagating between the components.

### Supplementary Note 14

The computer-readable recording medium according to supplementary note 13,
wherein the anomaly propagation estimation model is generated by machine learning, with a normal data series acquired in a time series from the plurality of the components, an anomaly level data series for use in learning obtained by converting the normal data series, and the information as learning data in the learning.

### Supplementary Note 15

The computer-readable recording medium according to supplementary note 14,
wherein the information is a causal graph generated using the normal data series.

### Supplementary Note 16

The computer-readable recording medium according to any one of supplementary notes 13 to 15, the program including instructions that cause the computer to carry out:
a step of inputting the anomaly level data series and the anomaly propagation likelihood to an anomaly cause estimation model, estimating a cause of the anomaly that occurred, and outputting anomaly cause information indicating the estimated cause.

### Supplementary Note 17

The computer-readable recording medium according to supplementary note 16,
wherein the anomaly cause estimation model evaluates an overall consistency obtained using a consistency between the anomaly level data series and an anomaly propagation scenario and a likelihood of the anomaly propagation scenario holding true which is based on the anomaly propagation likelihood.

### Supplementary Note 18

The computer-readable recording medium according to supplementary note 16 or 17;
wherein the anomaly cause information is a likelihood of each of the components being the anomaly cause at a predetermined point in time.

Although the present invention of this application has been described with reference to exemplary embodiments, the present invention of this application is not limited to the above exemplary embodiments. Within the scope of the present invention of this application, various changes that can be understood by those skilled in the art can be made to the configuration and details of the present invention of this application.

### INDUSTRIAL APPLICABILITY

As described above, according to the present invention, it is possible to estimate a true anomaly cause of the detected anomaly based on propagation of an anomaly, when an anomaly is detected. The present invention is useful in fields where it is necessary to estimate a fundamental anomaly cause of a system.

### LIST OF REFERENCE SIGNS

10 Anomaly cause estimation apparatus
11 Anomaly detection unit
12 Anomaly propagation estimation unit
13 Anomaly cause estimation unit
14 Setting unit
15 Causal graph generation unit
16 Output information generation unit
20 Input device
30 Storage device
40 Output device
110 Computer
111 CPU
112 Main memory
113 Storage device
114 Input interface
115 Display controller
116 Data reader/writer
117 Communications interface
118 Input device
119 Display device
120 Recording medium
121 Bus

What is claimed is:

1. An anomaly cause estimation apparatus comprising:
one or more memories storing instructions; and
one or more processors configured to execute the instructions to:
convert a data series acquired in a time series from a plurality of components provided in a target system into an anomaly level data series, and detect an anomaly based on the obtained anomaly level data series; and
input a target anomaly level data series, extracted from the anomaly level data series, for a period before a point in time at which the anomaly is detected, a target data series corresponding to the target anomaly level data series, and information indicating a causal relationship between the components to an anomaly propagation estimation model, and estimate an anomaly propagation likelihood of the anomaly propagating between the components.

2. The anomaly cause estimation apparatus according to claim 1,
wherein the anomaly propagation estimation model is generated by machine learning, with a normal data series acquired in a time series from the plurality of the components, an anomaly level data series for use in learning obtained by converting the normal data series using the anomaly detection means, and the information as learning data in the learning.

3. The anomaly cause estimation apparatus according to claim 2,
wherein the information is a causal graph generated using the normal data series.

4. The anomaly cause estimation apparatus according to claim 1, further comprising:
input the anomaly level data series and the anomaly propagation likelihood to an anomaly cause estimation model, estimate a cause of the anomaly that occurred, and output anomaly cause information indicating the estimated cause.

5. The anomaly cause estimation apparatus according to claim 4,
wherein the anomaly cause estimation model evaluates an overall consistency obtained using a consistency between the anomaly level data series and an anomaly propagation scenario and a likelihood of the anomaly propagation scenario holding true which is based on the anomaly propagation likelihood.

6. The anomaly cause estimation apparatus according to claim 4,
wherein the anomaly cause information is a likelihood of each of the components being the anomaly cause at a predetermined point in time.

7. An anomaly cause estimation method comprising:
converting a data series acquired in a time series from a plurality of components provided in a target system into an anomaly level data series;
detecting an anomaly based on the obtained anomaly level data series; and
inputting a target anomaly level data series, extracted from the anomaly level data series, for a period before a point in time at which the anomaly is detected, a target data series corresponding to the target anomaly level data series, and information indicating a causal relationship between the components to an anomaly propagation estimation model, and estimating an anomaly propagation likelihood of the anomaly propagating between the components.

8. The anomaly cause estimation method according to claim 7,
wherein the anomaly propagation estimation model is generated by machine learning, with a normal data series acquired in a time series from the plurality of the components, an anomaly level data series for use in learning obtained by converting the normal data series, and the information as learning data in the learning.

9. The anomaly cause estimation method according to claim 8,
wherein the information is a causal graph generated using the normal data series.

10. The anomaly cause estimation method according to claim 7, further comprising:
inputting the anomaly level data series and the anomaly propagation likelihood to an anomaly cause estimation model, estimating a cause of the anomaly that occurred, and outputting anomaly cause information indicating the estimated cause.

11. The anomaly cause estimation method according to claim 10,
wherein the anomaly cause estimation model evaluates an overall consistency obtained using a consistency between the anomaly level data series and an anomaly propagation scenario and a likelihood of the anomaly propagation scenario holding true which is based on the anomaly propagation likelihood.

12. The anomaly cause estimation method according to claim 10,
wherein the anomaly cause information is a likelihood of each of the components being the anomaly cause at a predetermined point in time.

13. A non-transitory computer-readable recording medium that includes a program recorded thereon, the program including instructions that cause a computer to carry out:
converting a data series acquired in a time series from a plurality of components provided in a target system into an anomaly level data series;
detecting an anomaly based on the obtained anomaly level data series; and
inputting a target anomaly level data series, extracted from the anomaly level data series, for a period before a point in time at which the anomaly is detected, a target data series corresponding to the target anomaly level data series, and information indicating a causal relationship between the components to an anomaly propagation estimation model, and estimating an anomaly propagation likelihood of the anomaly propagating between the components.

14. The non-transitory computer-readable recording medium according to claim 13,
wherein the anomaly propagation estimation model is generated by machine learning, with a normal data series acquired in a time series from the plurality of the components, an anomaly level data series for use in learning obtained by converting the normal data series, and the information as learning data in the learning.

15. The non-transitory computer-readable recording medium according to claim 14,
wherein the information is a causal graph generated using the normal data series.

16. The non-transitory computer-readable recording medium according to claim 13, the program including instructions that cause the computer to carry out:
inputting the anomaly level data series and the anomaly propagation likelihood to an anomaly cause estimation model, estimating a cause of the anomaly that occurred, and outputting anomaly cause information indicating the estimated cause.

17. The non-transitory computer-readable recording medium according to claim 16,
wherein the anomaly cause estimation model evaluates an overall consistency obtained using a consistency between the anomaly level data series and an anomaly propagation scenario and a likelihood of the anomaly propagation scenario holding true which is based on the anomaly propagation likelihood.

18. The non-transitory computer-readable recording medium according to claim 16;
wherein the anomaly cause information is a likelihood of each of the components being the anomaly cause at a predetermined point in time.
